(19) United States
(12) Patent Application Publication
(10) Pub. No.: US 2020/0251783 A1
(43) Pub. Date: Aug. 6, 2020

(54) SECONDARY BATTERY

(71) Applicant: Honda Motor Co.,Ltd., Tokyo (JP)

(72) Inventors: Wataru SHIMIZU, Saitama (JP); Masahiro OHTA, Saitama (JP); Toru SUKIGARA, Saitama (JP)

(73) Assignee: Honda Motor Co.,Ltd., Tokyo (JP)

(21) Appl. No.: 16/779,671

(22) Filed: Feb. 3, 2020

(30) Foreign Application Priority Data
Feb. 5, 2019 (JP) 2019-018602

(51) Int. Cl. H01M 10/0583; H01M 4/78

(52) U.S. Cl. CPC H01M 10/0583; H01M 2004/025; H01M 4/78

(57) ABSTRACT

The secondary battery includes: a negative electrode layer sheet formed by laminating a negative electrode active material layer on each negative electrode current collector of a negative electrode current collector sheet in which the negative electrode current collectors adjacent to each other are partially connected at a bent connection portion; a positive electrode layer sheet formed by laminating a positive electrode active material layer on each positive electrode current collector of a positive electrode current collector sheet in which the positive electrode current collectors adjacent to each other are partially connected at a bent connection portion; and a solid electrolyte body disposed so as to clamp the negative electrode layer sheet from both sides. A solid battery laminate is formed by bending the negative electrode layer sheet, the positive electrode layer sheet, and the solid electrolyte body at the bent connection portions to form into a substantially zigzag shape.

### CROSS-REFERENCE TO RELATED APPLICATION

This application claims the priority benefit of Japan Application No. 2019-018602, filed on Feb. 5, 2019. The entirety of the above-mentioned patent application is hereby incorporated by reference herein and made a part of this specification.

### BACKGROUND OF THE DISCLOSURE

### Technical Field

The disclosure relates to a secondary battery.

### Description of Related Art

In various products and fields such as smartphones and electric vehicles, an increase in capacity, voltage, and energy density of a battery is required, and research and development is actively performed. In addition, currently, a lithium-ion battery (secondary battery) mainly composed of a positive electrode, a negative electrode, a separator, and an electrolytic solution is widely used as the battery.

On the other hand, a solid battery (secondary battery) which uses an inorganic solid electrolyte instead of an electrolytic solution has many advantages such as lower risk of ignition, high thermal stability at high and low temperatures, wide operation temperature range, higher degree of freedom in design, low occurrence of side reactions due to a movement of Li ions only, high resistance to deterioration, excellent handling ability, high productivity, and no liquid leakage. Therefore, the solid battery has attracted a lot of attention.

Patent literature 1 (Japanese Laid-open No. 2015-118870) discloses a solid battery (a solid battery laminate of solid batteries) which is formed by applying a positive electrode mixture to the surface of a positive electrode current collector (positive electrode current collector foil) to thereby form a positive electrode layer, applying a negative electrode mixture to the surface of a negative electrode current collector (negative electrode current collector foil) to thereby form a negative electrode layer and laminating and pressing the positive electrode layer, a solid electrolyte, the negative electrode layer, a solid electrolyte, the positive electrode layer, etc. sequentially.

Patent literature 2 (Japanese Laid-open No. 2011-222288) discloses a solid battery (a solid battery laminate or structure of solid batteries) having a curved portion and a flat portion by laminating a positive electrode layer, a solid electrolyte layer, and a negative electrode layer so as to dispose the solid electrolyte layer between the positive electrode layer and the negative electrode layer, and then performing winding or folding operation.

Here, in the solid battery, to ensure and maintain the performance that is designed, press formation at a high surface pressure in a state that a laminate is formed and a subsequent high restraint pressure are required.

Consequently, a wound battery 1 (a laminate 2) disclosed in patent literature 2 can be easily produced, but cracking or chipping is prone to occur, especially in the mixture of a curved portion 3, due to the pressure during the press formation and a high restraint pressure, and distortion may occur (see FIG. 10). When such cracking, chipping, or distortion occurs, yield degradation, safety reduction, lowing of initial performance and shortening of cycle life may occur.

One or some exemplary embodiments of the disclosure provide a secondary battery capable of forming a highly reliable laminate which is not prone to crack, chip, or distort even when a high surface pressure during press formation and a subsequent high restraint pressure are applied.

The present inventors found an approach by which generation of cracking, chipping, or distortion can be suppressed even when a high surface pressure during press formation and a subsequent high restraint pressure are applied and a highly reliable laminate can be formed, and the embodiments of the disclosure are accomplished accordingly.

### SUMMARY

(1) The secondary battery of an embodiment of the disclosure includes: a negative electrode layer sheet (for example, a negative electrode layer sheet 15 described later) which is formed by laminating a negative electrode active material layer (for example, a negative electrode active material layer 11 described later) on each negative electrode current collector of a negative electrode current collector sheet (for example, a current collector sheet negative electrode 19 described later) in which negative electrode current collectors (for example, negative electrode current collectors 10 described later) adjacent to each other in a lamination direction (for example, a lamination direction T3 described later) are partially connected at a bent connection portion (for example, a bent connection portion 20 described later); a positive electrode layer sheet (for example, a positive electrode layer sheet 16 described later) which is formed by laminating a positive electrode active material layer (for example, a positive electrode active material layer 13 described later) on each positive electrode current collector of a positive electrode current collector sheet (for example, a positive electrode current collector sheet 22 described later) in which positive electrode current collectors (for example, a positive electrode current collector 14 described later) adjacent to each other in the lamination direction are partially connected at a bent connection portion (for example, a bent connection portion 20 described later); and an electrolyte body (for example, a solid electrolyte sheet 17 described later) interposed between the negative electrode active material layer and the positive electrode active material layer; and the secondary battery includes a battery laminate (for example, a solid battery laminate B described later) which is formed by bending the negative electrode layer sheet and the positive electrode layer sheet at the bent connection portions to arrange the negative electrode layer sheet and the positive electrode layer sheet in a substantially zigzag shape, and integrated by sequentially laminating a negative electrode current collector layer (for example, a negative electrode current collector layer 10 described later), a negative electrode active material layer, an electrolyte layer (for example, a solid electrolyte layer 12 described later), a positive electrode active material layer (for example, a positive electrode current collector layer 14 described later), a positive electrode current collector layer, a positive electrode active material layer, an electrolyte layer, a negative electrode active material layer, a negative electrode current collector layer.

(2) In the above-mentioned (1) of the embodiment of the disclosure, the electrolyte body may be an electrolyte sheet formed in a sheet shape, the electrolyte sheet may be disposed so as to clamp each of the negative electrode current collectors and the negative electrode active material layers of the negative electrode layer sheet from both sides, and the negative electrode layer sheet, the positive electrode layer sheet, and the electrolyte sheet may be bent at the bent connection portions and arranged in a substantially zigzag shape.

(3) In the above-mentioned (1) of the embodiment of the disclosure, the electrolyte body may be an electrolyte solution, and the electrolyte layer may be composed of the electrolyte solution and a separator.

(4) In any one of the above-mentioned (1) to (3) of the embodiment of the disclosure, the bent connection portion may arranged in the negative electrode layer sheet in a manner that one end (for example, one end 15d described later) sides of the adjacent negative electrode current collectors in a depth direction (for example, a depth direction T2 described later) are connected to each other, and the bent connection portion may be arranged in the positive electrode layer sheet in a manner that one end (for example, one end 16d described later) sides of the adjacent positive electrode current collectors in the depth direction are connected to each other. The battery laminate may be configured in a manner that the other end (for example, the other end 16c described later) side of the positive electrode layer sheet is disposed on one end side of the negative electrode layer sheet, and one end side of the positive electrode layer sheet is disposed on the other end (for example, the other end 15c described later) side of the negative electrode layer sheet, and each of the plurality of positive electrode current collectors and positive electrode active material layers lined up in a width direction (for example, a width direction T1 described later) is alternately arranged to overlap one surface side, other surface side, and one surface side . . . of each of the plurality of negative electrode current collectors and negative electrode active material layers lined up in the width direction.

(5) In any one of the above-mentioned (1) to (4) of the embodiment of the disclosure, the electrolyte layer may be disposed in an outermost layer in a lamination direction (for example, a lamination direction T3 described later).

(6) In any one of the above-mentioned (2), (4), and (5) of the embodiment of the disclosure, the electrolyte sheet may be formed by arranging slits (for example, slits 18 of the solid electrolyte sheet 17 described later) in a portion that is bent together with the negative electrode layer sheet and the positive electrode layer sheet.

(7) In any one of the above-mentioned (1) to (6) of the embodiment of the disclosure, an end portion of the bent connection portion of the negative electrode layer sheet, the positive electrode layer sheet, or the electrolyte sheet formed by the slits may be formed in a concave arc shape.

(8) In any one of the above-mentioned (1) to (7) of the embodiment of the disclosure, the positive electrode active material layer and the negative electrode active material layer adjacent to each other in the lamination direction may be formed in a manner that the area of the negative electrode active material layer is equal to or larger than the area of the positive electrode active material layer.

(9) In any one of the above-mentioned (1) to (8) of the embodiment of the disclosure, the battery laminate is configured in a manner that the relationship of the dimensions in the depth direction and the width direction in a cross-sectional view may be as follows: the dimension of the positive electrode active material layer≤the dimension of the negative electrode active material layer≤the dimension of the electrolyte layer.

(10) In any one of the above-mentioned (1) to (9) of the embodiment of the disclosure, the electrolyte body may be a solid electrolyte body, and the secondary battery may be a solid battery (for example, a solid battery A described later).

### BRIEF DESCRIPTION OF THE DRAWINGS

FIG. 1 is a cross-section view showing a solid battery laminate and a solid battery (a battery laminate, a secondary battery) according to one embodiment of the disclosure.

FIG. 2 is a front view showing a negative electrode layer sheet of a solid battery laminate and a solid battery (a battery laminate, a secondary battery) according to one embodiment of the disclosure. FIG. 3 is a front view showing a positive electrode layer sheet of a solid battery laminate and a solid battery (a battery laminate, a secondary battery) according to one embodiment of the disclosure.

FIG. 4 is a perspective view showing a solid electrolyte sheet (an electrolyte body) of a solid battery laminate and a solid battery (a battery laminate, a secondary battery) according to one embodiment of the disclosure.

FIG. 5 is a front view showing a bent connection portion of a negative electrode current collector sheet and a positive electrode current collector sheet of a solid battery laminate and a solid battery (a battery laminate, a secondary battery) according to one embodiment of the disclosure.

FIG. 6 is a front view showing a state in which a negative electrode current collector sheet, a positive electrode current collector sheet, and a solid electrolyte sheet of a solid battery laminate and a solid battery (a battery laminate, a secondary battery) according to one embodiment of the disclosure are combined.

FIG. 7 is a front view showing a state in which the solid electrolyte sheet is omitted in FIG. 6.

FIG. 8 is a perspective view showing a situation in which a negative electrode current collector sheet, a positive electrode current collector sheet, and a solid electrolyte sheet of a solid battery laminate and a solid battery (a battery laminate, a secondary battery) according to one embodiment of the disclosure are combined and put into a substantially zigzag folded state.

FIG. 9 is a perspective view showing a variation example of a solid electrolyte sheet of a solid battery laminate and a solid battery (a battery laminate, a secondary battery) according to one embodiment of the disclosure.

FIG. 10 is a diagram showing a conventional solid battery laminate and solid battery.

### DESCRIPTION OF THE EMBODIMENTS

According to the exemplary embodiment of the disclosure, it is possible to provide a highly reliable secondary battery (a battery laminate) which can prevent the occurrence of cracking, chipping or distortion even when a high surface pressure during press formation and a subsequent high restraint pressure are applied.

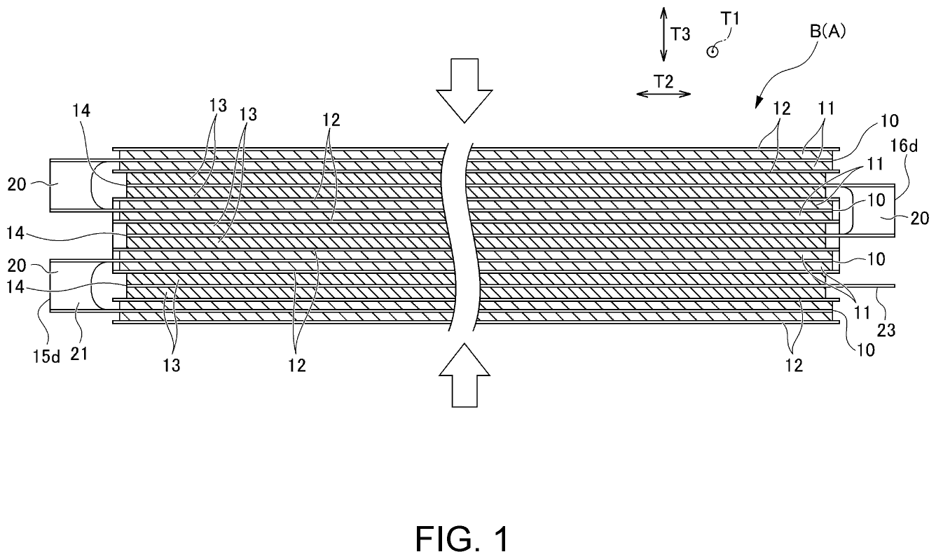

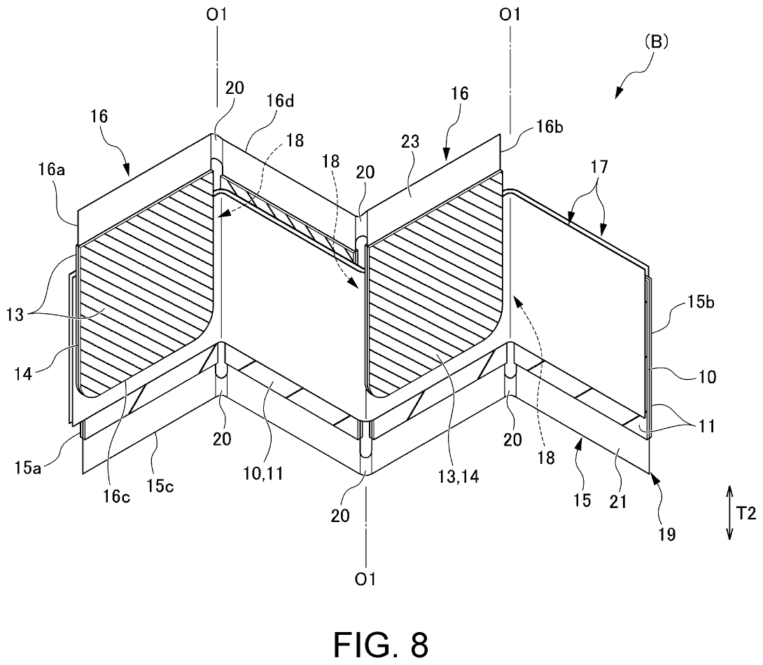

Hereinafter, a secondary battery according to one embodiment of the disclosure is described with reference to FIG. 1 to FIG. 9. In the present embodiment, the description is made on the assumption that the secondary battery according to the disclosure is a solid battery.

As shown in FIG. 1, the solid battery (a secondary battery) A of the present embodiment includes a solid battery laminate (a battery laminate) B which is formed by integrally and sequentially laminating a negative electrode current collector layer 10, a negative electrode active material layer (a negative electrode mixture layer) 11, a solid electrolyte layer 12, a positive electrode active material layer (a positive electrode mixture layer) 13, a positive electrode current collector layer 14, a positive electrode active material layer (a positive electrode mixture layer) 13, a solid electrolyte layer 12, a negative electrode active material layer 11, and a negative electrode current collector layer 10.

In addition, the solid battery A is configured in a manner that the plurality of negative electrode current collector layers 10 is electrically connected to each other and connects a negative electrode current collector tab (not shown), the plurality of positive electrode current collector layers 14 is electrically connected to each other and connects a positive electrode current collector tab (not shown), and the solid battery laminate B is accommodated in an exterior body (not shown) such as a laminate film. Moreover, an external terminal is attached to the negative electrode current collector tab or the positive electrode current collector tab, and electrical connection with an external device can be achieved by disposing the external terminal outside the exterior body.

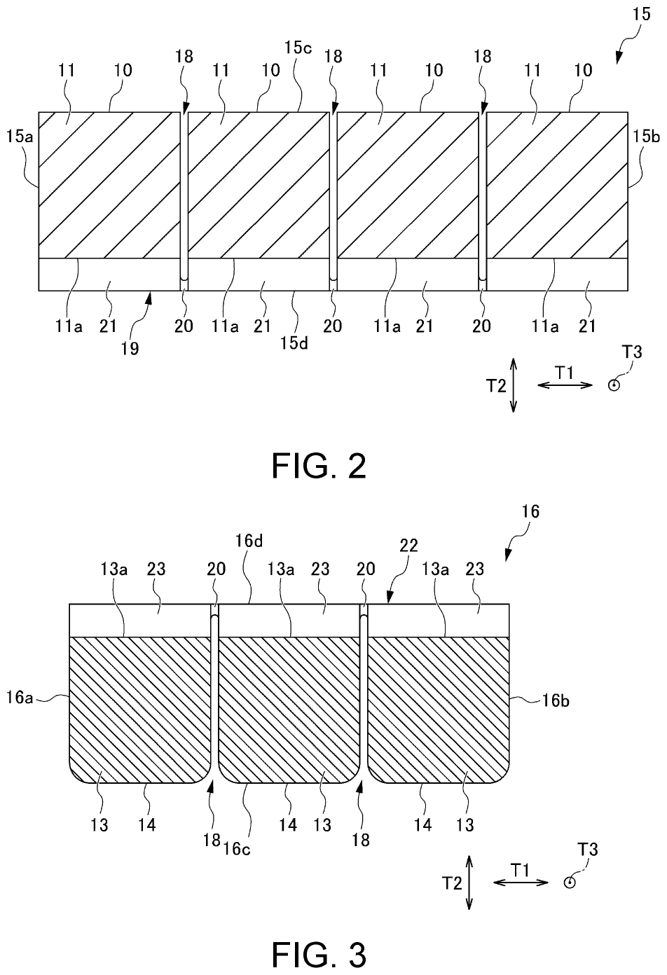

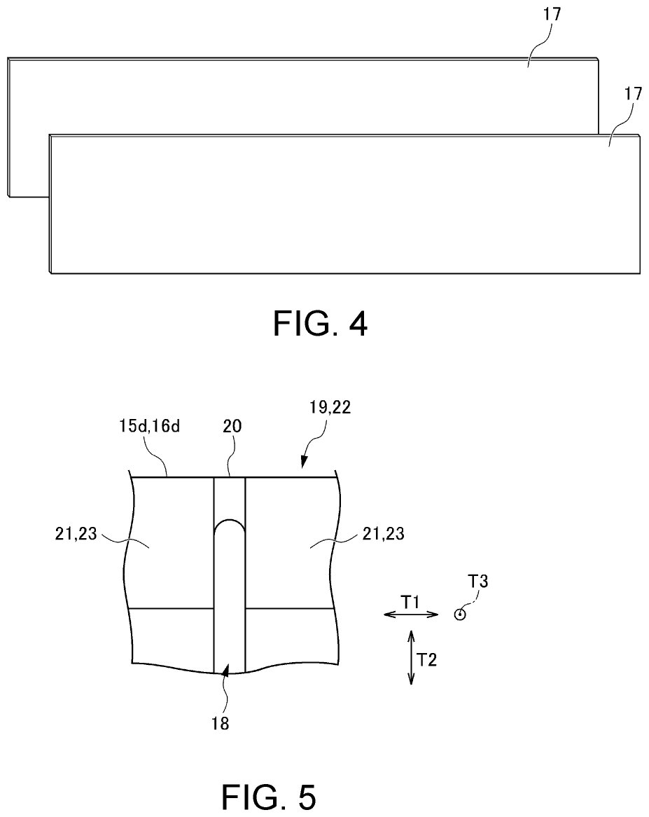

On the other hand, in the solid battery A of the present embodiment, the plurality of the negative electrode current collector layers 10 and the negative electrode active material layers 11 forming the solid battery laminate B is configured by using a single piece of sheet-like negative electrode layer sheet 15 as shown in FIG. 2, the plurality of the positive electrode current collector layers 14 and the positive electrode active material layers 13 is configured by using a single piece of sheet-like positive electrode layer sheet 16 as shown in FIG. 3, and the plurality of the solid electrolyte layers 12 is configured by using two pieces of sheet-like solid electrolyte sheets (an electrolyte body, an electrolyte sheet) 17 as shown in FIG. 4.

### [Negative Electrode Layer Sheet]

Specifically, as shown in FIG. 2, the negative electrode layer sheet 15 is configured by including a negative electrode current collector sheet 19 which is formed by arranging a plurality of slits 18 extending along a depth direction T2 from one end 15c to the other end 15d, the slits 18 being formed in a substantially rectangular sheet shape and a strip shape having a predetermined width dimension and depth dimension and arranged at predetermined intervals between one side end 15a and the other side end 15b in a width direction T1.

As for the negative electrode current collector sheet 19, in the width direction T1, a portion between the one side end 15a and the nearest slit 18, a portion between adjacent slits 18, and a portion between the other side end 15b and the nearest slit 18 form a plurality of negative electrode current collectors (negative electrode current collector foils) 10 with the same shape and the same size, a portion from the distal end of each slit 18 to the other end 15d of the negative electrode current collector sheet 19 where no slit 18 is formed is set as a bent connection portion 20 which electrically and mechanically connects adjacent negative electrode current collectors 10 to each other. In addition, as shown in FIG. 2 and FIG. 5, each bent connection portion 20 may be formed by pressing in a manner that, for example, the surface being the outer surface becomes a convex arc shape and the surface being the inner surface becomes a concave arc shape when the portion is bent.

As shown in FIG. 2, in the negative electrode layer sheet 15, negative electrode active material layers (negative electrode mixture) 11 are integrally laminated on one surfaces and the other surfaces (including side surfaces (end surfaces), for example) of the plurality of negative electrode current collectors 10 of the negative electrode current collector sheet 19. In the negative electrode current collector 10 of the negative electrode current collector sheet 19, a portion at the other end 15d side in the depth direction T2 where the bent connection portion 20 is located, that is, a part of region from the other end 15d of the negative electrode current collector sheet 19 to the one end 15c side in the depth direction T2 is set as a negative electrode active material layer non-formed portion 21, and no negative electrode active material layer 11 is laminated on the negative electrode active material layer non-formed portion 21.

Moreover, in the present embodiment, four negative electrode current collectors 10 are provided by forming three slits 18 in the negative electrode current collector sheet 19. The four negative electrode current collectors 10 constitute the negative electrode current collector layer (negative electrode current collector foil) 10 described above.

In addition, each negative electrode current collector 10 and the negative electrode active material layer 11 laminated on each negative electrode current collector 10 of the present embodiment may, for example, have an area that is equal to or larger than the area of the corresponding positive electrode current collector 14 and the positive electrode active material layer 13 laminated on each positive electrode current collector 14 described later. Thus, in the present embodiment, each positive electrode current collector 14 and the positive electrode active material layer 13 laminated on each positive electrode current collector 14 are formed by chamfering corner portions, whereas each negative electrode current collector 10 and the negative electrode active material layer 11 laminated on each negative electrode current collector 10 is formed in a substantially square shape in a plan view without chamfering corner portions.

The bent connection portion 20 of the negative electrode current collector sheet 19 may also serve as the negative electrode current collector tab.

In the negative electrode current collector sheet 19, the portion (a distal end portion) at the other end 15d side in the depth direction T2 of the slit 18, that is, the end portion of each folding connection portion 20 forming the slit 18 may be formed, for example, in an arc shape (a convex arc shape for the distal end portion of the slit 18, and a concave arc shape for the end portion of the bent connection portion 20). By forming this portion into an arc shape, occurrence of cracking and the like in the slit (18) and the bent connection portion 20 can be prevented, and the negative electrode current collector sheet 19 (the negative electrode layer sheet 15) with high durability and reliability can be achieved.

### [Positive Electrode Layer Sheet]

Next, as shown in FIG. 3, the positive electrode layer sheet 16 is configured by including a positive electrode current collector sheet 22 which is formed by arranging a plurality of slits 18 extending along the depth direction T2 from one end 16c to the other end 16d, the slits 18 being formed in a substantially rectangular sheet shape and a strip shape having a predetermined width dimension and depth dimension and arranged at predetermined intervals between one side end 16a and the other side end 16b in the width direction T1.

As for the positive electrode current collector sheet 22, in the width direction T1, a portion between the one side end 16a and the nearest slit 18, a portion between adjacent slits 18, and a portion between the other side end 16b and the nearest slit 18 form a plurality of positive electrode current collectors (positive electrode current collector foils) 14 with the same shape and the same size, a portion from the distal end of each slit 18 to the other end 16d of the positive electrode current collector sheet 22 where no slit 18 is formed is set as the bent connection portion 20 which electrically and mechanically connects adjacent negative electrode current collectors 14 to each other. In addition, as shown in FIG. 3 and FIG. 5, each bent connection portion 20 may be formed by pressing in a manner that, for example, the surface being the outer surface becomes a convex arc shape and the surface being the inner surface becomes a concave arc shape when the portion is bent.

As shown in FIG. 3, in the positive electrode layer sheet 16, the positive electrode active material layers (positive electrode mixture) 13 are integrally laminated on one surfaces and the other surfaces (including side surfaces (end surfaces), for example) of the plurality of positive electrode current collectors 14 of the positive electrode current collector sheet 22. In the positive electrode current collector 14 of the positive electrode current collector sheet 22, a portion at the other end 16d side in the depth direction T2 where the bent connection portion 20 is located, that is, a part of region from the other end 16d of the positive electrode current collector sheet 22 to the one end 16c side in the depth direction T2 is set as a positive electrode active material layer non-formed portion 23, and no positive electrode active material layer 13 is laminated on the positive electrode active material layer non-formed portion 23.

Moreover, in the present embodiment, three positive electrode current collectors 14 are provided by forming two slits 18 in the positive electrode current collector sheet 22. The three positive electrode current collectors 14 constitute the positive electrode current collector layer (positive electrode current collector foil) 14 described above.

In addition, as mentioned above, each positive electrode current collector 14 and the positive electrode active material layer 13 laminated on each positive electrode current collector 14 of the present embodiment are formed by chamfering corner parts so that the area is smaller than (or may be equal to) that of the corresponding negative electrode current collector 10 and the negative electrode active material layer 11 laminated on each positive electrode current collector 10.

The bent connection portion 20 of the positive electrode current collector sheet 22 may also serve as a positive electrode current collector tab.

In the positive electrode current collector sheet 22, the portion (a distal end portion) at the other end 16d side in the depth direction T2 of the slit 18, that is, the end portion of each folding connection portion 20 forming the slit 18 may be formed, for example, in an arc shape (a convex arc shape for the distal end portion of the slit 18, and a concave arc shape for the end portion of bent connection 20). By forming this portion into an arc shape, occurrence of cracking and the like in the slit (18) and the bent connection portion 20 can be prevented, and the positive electrode current collector sheet 22 (the positive electrode layer sheet 16) with high durability and reliability can be achieved.

### [Solid Electrolyte Sheet (Solid Electrolyte Body)]

As shown in FIG. 4, the solid electrolyte sheet 17 forming the solid electrolyte layer 12 includes an electrolyte that conducts ions between the negative electrode active material layer 11 laminated on the negative electrode current collector sheet 19 and the positive electrode active material layer 13 laminated on the positive electrode current collector sheet 22, and is formed in a rectangular sheet shape and a strip shape.

The solid electrolyte sheet 17 has a width dimension equal to that of the negative electrode current collector sheet 19 and the negative electrode layer sheet 15, and is formed in a rectangular sheet shape with a depth dimension substantially equal to the depth dimension of the negative electrode current collector sheet 19 from the one end 15c to the negative electrode active material layer non-formed portion 21, that is, substantially equal to the depth dimension of the negative electrode active material layer 11.

### [Solid Battery Laminate (Solid Battery)]

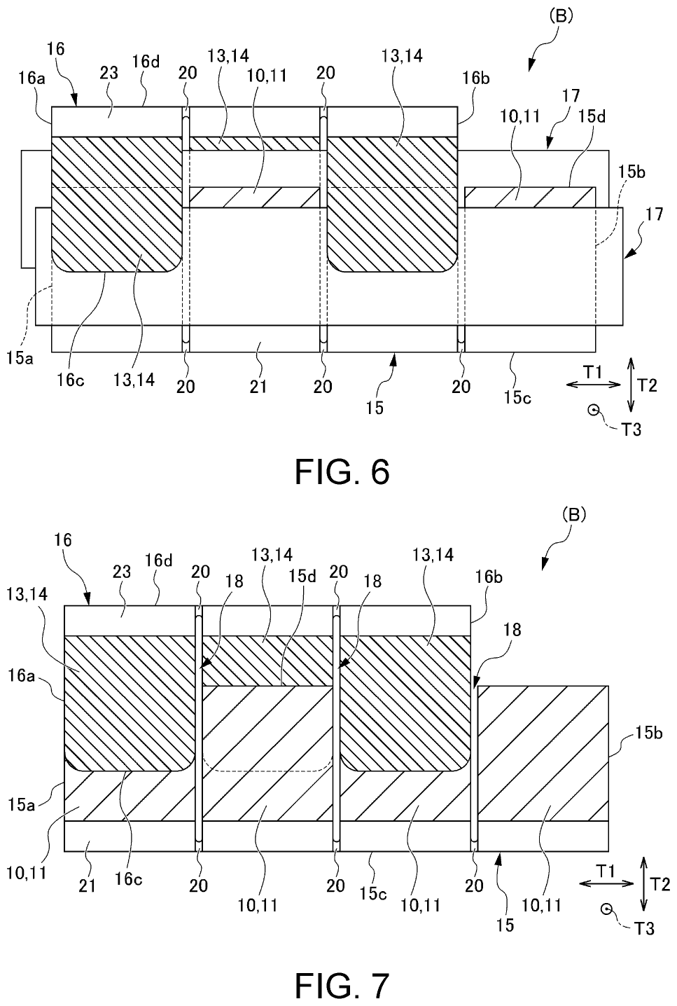

As shown in FIGS. 6 to 8, in the solid battery laminate B (solid battery A) of the present embodiment, the solid electrolyte sheets 17 are superposed on both one surface and the other surface of the negative electrode layer sheet 15, and the positive electrode layer sheet 16 is arranged in a manner that the one end 16c in the depth direction T2 is disposed on the other end 15d side of the negative electrode layer sheet 15 and the slits 18 of the positive electrode layer sheet 16 are aligned with the slits 18 of the negative electrode layer sheet 15.

In addition, each of the plurality of positive electrode current collectors 14 and the positive electrode active material layers 13 lined up in the width direction T1 of the positive electrode layer sheet 16 is arranged so as to alternately overlap with one surface side, the other surface side, one surface side . . . of each of the plurality of negative electrode current collectors 10 and the negative electrode active material layers 11 of the negative electrode layer sheet 15 with the solid electrolyte sheets 17 interposed therebetween.

A plurality of bent connection portions 20 of the positive electrode current collector sheet 22 and a plurality of bent connection portions 20 of the negative electrode current collector sheet 19 are bent at the axial center 01 extending in the depth direction T2, and formed in a substantially zigzag shape such that the negative electrode current collector layer 10, the negative electrode active material layer 11, the solid electrolyte layer 12, the positive electrode active material layer 13, the positive electrode current collector layer 14, the positive electrode active material layer 13, the solid electrolyte layer 12, the negative electrode active material layer 11, the negative electrode current collector layer 10 . . . are laminated sequentially.

Additionally, as described above, at a stage in which the solid battery A of the present embodiment is formed in a substantially zigzag shape so that the negative electrode current collector layer 10, the negative electrode active material layer 11, the solid electrolyte layer 12, the positive electrode active material layer 13, the positive electrode current collector layer 14, the positive electrode active material layer 13, the solid electrolyte layer 12, the negative electrode active material layer 11, the negative electrode current collector layer 10 . . . are laminated sequentially, the solid battery laminate B is formed by pressing in the lamination direction T3 and firmly bringing the negative electrode current collector layer 10, the negative electrode active material layer 11, the solid electrolyte layer 12, the positive electrode active material layer 13, the positive electrode current collector layer 14, the positive electrode active material layer 13, the solid electrolyte layer 12, the negative electrode active material layer 11, the negative electrode current collector layer 10 . . . into close contact for integration, as shown in FIG. 1.

Besides, at this time, in the solid battery A of the present embodiment, the negative electrode active material layer 11 and the positive electrode active material layer 13 adjacent to each other in the lamination direction T3 form the solid battery laminate B in a manner that an end portion 11a of the negative electrode active material layer 11 on the negative electrode active material layer non-formed portion 21 side is overlapped with an end portion (16c) of the positive electrode active material layer 13 at the same side in the depth direction T2, the end portion (16c) being at a side opposite to the positive electrode active material layer non-formed portion 23, and an end portion 13a of the positive electrode active material layer 13 on the positive electrode active material layer non-formed portion 23 side is overlapped with an end portion (15c) of the negative electrode active material layer 11 at the same side in the depth direction T2, the end portion (15c) being at a side opposite to the negative electrode active material layer non-formed portion 21 (see FIG. 2 and FIG. 3).

In addition, in the present embodiment, the rectangular sheet-shaped and strip-shaped solid electrolyte sheet (solid electrolyte body) 17 is disposed between the negative electrode layer sheet 15 and the positive electrode layer sheet 16 which are arranged in a substantially zigzag shape and continuously adjacent to each other; however, it is sufficient that the solid electrolyte body is interposed between the adjacent negative electrode layer sheet 15 and positive electrode layer sheet 16, for example, other means and methods may be used, such as disposing a bag-shaped solid electrolyte body so as to enclose the negative electrode layer sheet 15 or the positive electrode layer sheet 16, or applying a solid electrolyte body (a solid electrolyte layer) directly to the negative electrode layer sheet 15 or the positive electrode layer sheet 16.

Here, the negative electrode active material contained in the negative electrode active material layer 11 includes, for example, lithium metals, lithium alloys such as Li—Al alloy and Li—In alloy, lithium titanates such as Li₄Ti₅O₁₂, carbon materials such as carbon fiber and graphite. However, the negative electrode active material is not particularly limited, and a material known as the negative electrode active material for solid state battery can be used. Additionally, the composition thereof is also not particularly limited and may contain a solid electrolyte, a conductive auxiliary agent, a binder and the like.

The material of the negative electrode current collector sheet 19 (the negative electrode current collector 10) includes metals such as SUS, Cu, Ni, Cr, Au, Pt, Al, Fe, Ti, and Zn. In addition, the shape of the negative electrode current collector includes, for example, a foil shape, a plate shape, a mesh shape, a nonwoven fabric shape, a foam shape and so on. Moreover, in order to enhance adhesiveness, carbon may be disposed on the surface of the current collector, or the surface may be roughened. However, the negative electrode current collector sheet 19 is not particularly limited, and a known current collector that can be used for the negative electrode of the solid battery A may be used.

The positive electrode active material contained in the positive electrode active material layer 13 include, for example, sulfides such as titanium disulfides, molybdenum disulfides, lithium sulfide and sulfur, transition metal chalcogenides such as niobium selenide, transition metal oxides such as lithium nickelates (LiNiO₂), lithium manganates (LiMnO₂, LiMn₂O₄), lithium cobaltates (LiCoO₂) and the like.

In addition, the positive electrode active material is not particularly limited, and a material known as the positive electrode active material for the solid battery A may be used. The composition thereof is also not particularly limited and may contain a solid electrolyte, a conductive auxiliary agent, a binder and the like.

The material for the positive electrode current collector sheet 22 (the positive electrode current collector 14) includes, for example, metals such as SUS, Al, Ni, Cr, Au, Pt, Fe, Ti, Zn, conductive carbon (for example, graphite and CNT), and the like. In addition, the shape of the positive electrode current collector includes a foil shape, a plate shape, a mesh shape, a nonwoven fabric shape, a foam shape and the like. Moreover, in order to enhance adhesiveness, carbon may be disposed on the surface of the current collector, or the surface may be roughened. Additionally, the positive electrode current collector sheet 22 is not particularly limited, and a known current collector that can be used for the positive electrode of the solid battery A may be used.

The solid electrolyte of the solid electrolyte layer 12 (the solid electrolyte sheet 17) includes, for example, inorganic solid electrolytes of a lithium-containing salt and the like, such as sulfide inorganic solid electrolyte, NASICON oxide inorganic solid electrolyte, perovskite oxide inorganic solid electrolyte; polymer-based solid electrolytes such as polyethylene oxide; and gel-based solid electrolytes containing a lithium-containing salt or a lithium ion conductive ionic liquid. However, the solid electrolyte is not particularly limited and contains a binder and the like as necessary. The composition ratio of each substance contained in the solid electrolyte is not particularly limited as long as the battery can operate appropriately. The solid electrolyte layer 12 (the solid electrolyte sheet 17) may be formed from the solid electrolyte only, or may be a solid electrolyte layer in which the solid electrolyte is fixed to a porous substrate made of a chemically stable material. The thickness and the shape of the solid electrolyte layer 12 (the solid electrolyte sheet 17) are not particularly limited as long as ion conduction between the positive electrode layer sheet 16 and the negative electrode layer sheet 15 can be realized. Additionally, the production method is not particularly limited either.

Therefore, the solid battery A of the present embodiment includes: the negative electrode layer sheet 15 formed by laminating the negative electrode active material layer 11 on the negative electrode current collector 10 of the negative electrode current collector sheet 19 in which the negative electrode current collectors 10 adjacent to each other in the lamination direction T3 are partially connected at the bent connection portion 20; the positive electrode layer sheet 16 formed by laminating the positive electrode active material layer 13 on the positive electrode current collector 14 of the positive electrode current collector sheet 22 in which the positive electrode current collectors 14 adjacent to each other in the lamination direction T3 are partially connected at the bent connection portion 20; and the solid electrolyte sheet 17 disposed so as to clamp the negative electrode current collector 10 and the negative electrode active material layer 11 of the negative electrode layer sheet 15 from both sides; and the negative electrode layer sheet 15, the positive electrode layer sheet 16 and the solid electrolyte sheet 17 are bent at the bent connection portion 20 to form a substantially zigzag shape, thereby forming a solid battery A in which the negative electrode current collector layer 10, the negative electrode active material layer 11, the solid electrolyte layer 12, the positive electrode active material layer 13, the positive electrode current collector layer 14, the positive electrode active material layer 13, the solid electrolyte layer 12, the negative electrode active material layer 11, the negative electrode current collector layer 10 . . . are sequentially laminated and integrated.

Thus, a conventional curved portion 3 is not required, and the occurrence of cracking, chipping, and distortion in the mixture (the negative electrode active material layer 11 or the positive electrode active material layer 13) due to a pressure during press formation and a high restraint pressure can be eliminated while maintaining the ease of production of the wound solid battery A.

Therefore, according to the solid battery A of the present embodiment, compared to the conventional wound solid battery, it is possible to provide a highly reliable solid battery A (a solid battery laminate B) capable of improving yield and safety, maintaining initial performance and extending service life.

One embodiment of the secondary battery according to the disclosure is described above, but the disclosure is not limited to the above-described embodiment, and changes may be appropriately made without departing from the spirit of the disclosure.

For example, in the present embodiment, the description is made on the assumption that the secondary battery according to the disclosure is a solid battery; however, the secondary battery according to the disclosure is not limited to a solid battery and may also be configured by interposing a liquid electrolyte (an electrolyte body) between the negative electrode layer sheet 15 and the positive electrode layer sheet 16 that are adjacent.

In this case, the liquid electrolyte (electrolyte body) is not particularly limited, and a known electrolyte body used for a lithium ion secondary battery may be used. A solvent constituting the electrolyte body includes, for example, ethylene carbonate, dimethyl carbonate, ethyl methyl carbonate, propylene carbonate and the like, and these solvents may be used in combination. Furthermore, the electrolyte constituting the electrolyte body includes lithium-containing salts such as LiPF₆, LiBF₄, LiClO₄, and lithium-containing ionic liquids such as LiTFSi, and these electrolytes may be used in combination. In addition, the electrolyte body may contain an additive and the like as needed.

Here, when the liquid electrolyte (an electrolyte body) is interposed, the secondary battery can be formed, for example, by arranging separators on both sides of at least one of the positive electrode layer sheet 16 and the negative electrode layer sheet 15, and then bending the positive electrode layer sheet 16, the negative electrode layer sheet 15 and the separators at the bent connection portion 20 to form a substantially zigzag shape, thereby sequentially laminating the negative electrode current collector layer 10, the negative electrode active material layer 11, the separator (an electrolyte body), the positive electrode active material layer 13, the positive electrode current collector layer 14, the positive electrode active material layer 13, the separator (an electrolyte body), the negative electrode active material layer 11, the negative electrode current collector layer 10.

In addition, the separator used for the secondary battery is not particularly limited as long as it can be impregnated with a liquid electrolyte (an electrolyte body) or the like, and a separator known as a separator of a lithium ion secondary battery may be used. For example, porous sheets such as nonwoven fabric and porous films may be used.

The material of the separator include is not particularly limited either, and includes, for example, polypropylene, polyethylene, polyethylene terephthalate, polybutylene terephthalate, ethylene-propylene copolymer, cellulose and the like. In addition, the basis weight and the thickness of the separator are not particularly limited either, and can be appropriately set according to the required performance of the secondary battery.

Furthermore, in the present embodiment, the description is made on the assumption that the solid electrolyte body according to the disclosure is the solid electrolyte sheet 17. In contrast, the solid electrolyte body may be provided by laminating the negative electrode active material layer 11 on the negative electrode current collector 10 of the negative electrode current collector sheet 19, and then laminating the solid electrolyte layer 12 on the negative electrode active material layer 11, or by laminating the positive electrode active material layer 13 on the positive electrode current collector 14 of the positive electrode current collector sheet 22, and then laminating the solid electrolyte layer 12 on the positive electrode active material layer 13.

In this case, it is possible to arrange an insulating layer formed by integrally laminating an insulating material and/or a solid electrolyte layer formed by integrally laminating a solid electrolyte (a negative electrode current collector coating layer composed of an insulating material and/or a solid electrolyte layer) on the negative electrode active material layer non-formed portion 21 of the negative electrode current collector sheet 19 and the end surface of the part of the negative electrode current collector sheet 19 forming the negative electrode active material layer non-formed portion 21, for example.

In addition, it is possible to arrange an insulating layer formed by integrally laminating an insulating material and/or a solid electrolyte layer formed by integrally laminating a solid electrolyte (a negative electrode current collector coating layer composed of an insulating material and/or a solid electrolyte layer) on the positive electrode active material layer non-formed portion 23 of the positive electrode current collector sheet 22 and the end surface of the part of the positive electrode current collector sheet 22 forming the positive electrode active material layer non-formed portion 23, for example.

Furthermore, the negative electrode current collector coating layer may be formed with a thickness equal to that of the negative electrode active material layer 11 (or a layer obtained by combining the negative electrode active material layer 11 and the solid electrolyte layer 12 laminated thereon). In addition, the positive electrode current collector coating layer may be formed with a thickness equal to that of the positive electrode active material layer 13 (or a layer obtained by combining the positive electrode active material layer 13 and the solid electrolyte layer 12 laminated thereon). In addition, as shown in FIG. 1, the solid battery A and the solid battery laminate B may be configured in a manner that the relationship of the dimensions in the depth direction

T2 (and the width direction T1) is as follows: the dimension of the positive electrode active material layer (positive electrode mixture layer) 13≤the dimension of the negative electrode active material layer (negative electrode mixture layer) 11≤the dimension of the electrolyte layer 12.

Accordingly, in a battery manufacturing process, when the solid battery laminate B is pressed in the lamination direction T3, no space is left at a portion of the negative electrode active material layer non-formed portion 21 of the negative electrode current collector sheet 19 or a portion of the positive electrode active material layer non-formed portion 23 of the positive electrode current collector sheet 22, and the negative electrode active material layer non-formed portion 21 or the positive electrode active material layer non-formed portion 23 does not induce the occurrence of cracks. In addition, the flatness tolerance and the parallelism tolerance of the obtained negative electrode laminate (a negative electrode for solid battery) and positive electrode laminate (a positive electrode for solid battery) can be minimized. As a result, the volume during the formation of multilayers can be reduced, which contributes to high energy.

The insulating material constituting the insulating layer includes, for example, resins having insulating properties, such as thermoplastic insulation resins like polyethylene, polypropylene, polystyrene, polycarbonate, methacrylic acid, and ABS resin, thermosetting insulating resins like phenol resin, epoxy resin, polyurethane, silicone resin, and alkyd resin, and so on. Moreover, the insulating material is not particularly limited.

The solid electrolyte of the solid electrolyte layer serving as the negative electrode current collector coating layer or the positive electrode current collector coating layer includes, for example, inorganic solid electrolytes of a lithium-containing salt and the like, such as sulfide inorganic solid electrolyte, NASICON oxide inorganic solid electrolyte, perovskite oxide inorganic solid electrolyte; polymer-based solid electrolytes such as polyethylene oxide; and gel-based solid electrolytes containing a lithium-containing salt or a lithium ion conductive ionic liquid. Additionally, it is possible to use the same material as the solid electrolyte used for the solid electrolyte layer 12 when forming the solid battery A, for example, and in particular, a sulfide-based inorganic solid electrolyte may be used. However, the solid electrolyte is not particularly limited either.

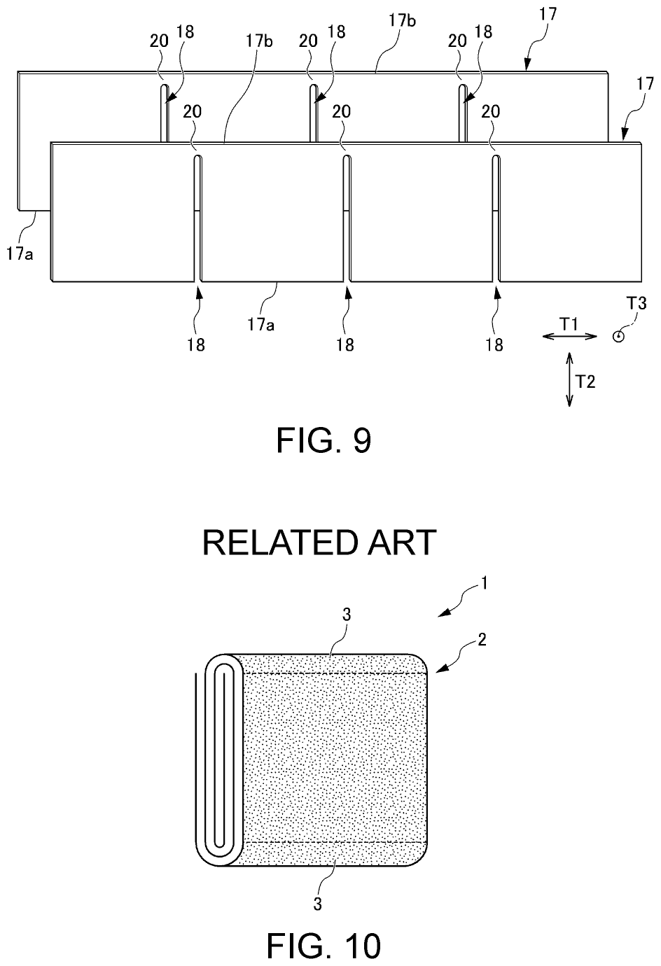

On the other hand, as shown in FIG. 9, when the solid electrolyte sheet 17 is used as in the present embodiment, the solid electrolyte sheet 17 may be formed to include slits 18 extending from one end 17a to the other end 17b side in the depth direction T2 at substantially the same intervals and sizes (length, width) as the negative electrode current collector sheet 19 and the positive electrode current collector sheet 22. In this case, it is also possible that the portion (the distal end portion) of the slit 18 on the other end 17b side in the depth direction T2 is formed in an arc shape (a convex arc shape for the distal end portion of the slit 18, and a concave arc shape for the end portion of the bent connection portion), for example. Accordingly, the slit portion (18) can be prevented from being cracking.

In this case, the density and the battery performance of the solid battery laminate B can be further improved, wherein the solid battery laminate B is obtained by being formed into a substantially zigzag shape and being pressed, and the substantially zigzag shape is formed by aligning the positions of the slits 18 of the negative electrode current collector sheet 19 and the positive electrode current collector sheet 22 with the positions of the slits 18 of the solid electrolyte sheet 17, when overlapping is performed, as in the present embodiment, on one surface and the other surface of the negative electrode layer sheet 15 respectively.

In addition, when the slits 18 are arranged in the solid electrolyte sheet 17, two pieces of solid electrolyte sheets 17 may be arranged in the following manner, that is, with respect to a plurality of negative electrode current collector sheets 19 and positive electrode current collector sheets 22 lined up in the width direction T1 of the negative electrode layer sheet 15, one of the solid electrolyte sheets 17 is alternately and sequentially arranged, from the one side end 15a side of the negative electrode layer sheet 15 in the width direction T1, on the one surface side of the negative electrode current collector sheet 19, the other surface side of the next negative electrode current collector sheet 19, the one surface side of a still next negative electrode current collector sheet 19, and the other surface side of a further next negative electrode current collector sheet 19, and the other of the solid electrolyte sheets 17 is alternately and sequentially arranged, from the one side end 15a side of the negative electrode layer sheet 15 in the width direction T1, on the other surface side of the negative electrode current collector sheet 19, the one surface side of the next negative electrode current collector sheet 19, the other surface side of the still next negative electrode current collector sheet 19, and the one surface side of the further next negative electrode current collector sheet 19. In this case, the two pieces of solid electrolyte sheets 17 can be entwined with each other and the two pieces of solid electrolyte sheets 17 can be entwined with the negative electrode layer sheet 15. During pressing and the like, the integrity between the solid electrolyte sheets 17 and the negative electrode layer sheet 15 (and the positive electrode layer sheet 16) can be increased, and a solid battery A having a further higher density and excellent battery performance can be formed.

What is claimed is:

1. A secondary battery comprising:
a negative electrode layer sheet, which is formed by laminating a negative electrode active material layer on each negative electrode current collector of a negative electrode current collector sheet in which the negative electrode current collectors adjacent to each other in a lamination direction are partially connected at a bent connection portion;
a positive electrode layer sheet, which is formed by laminating a positive electrode active material layer on each positive electrode current collector of a positive electrode current collector sheet in which the positive electrode current collectors adjacent to each other in the lamination direction are partially connected at a bent connection portion; and
an electrolyte body interposed between the negative electrode active material layer and the positive electrode active material layer; and the secondary battery comprising
a battery laminate which is formed by bending the negative electrode layer sheet and the positive electrode layer sheet at the bent connection portions to arrange the negative electrode layer sheet and the positive electrode layer sheet in a substantially zigzag shape, and integrated by sequentially laminating the negative electrode current collector, the negative electrode active material layer, the electrolyte body, the positive electrode active material layer, the positive electrode current collector, the positive electrode active material layer, the electrolyte body, the negative electrode active material layer, the negative electrode current collector.

2. The secondary battery according to claim 1, wherein the electrolyte body is an electrolyte sheet formed in a sheet shape; and
the electrolyte sheet is disposed so as to clamp each of the negative electrode current collectors and the negative electrode active material layers of the negative electrode layer sheet from both sides, and the negative electrode layer sheet, the positive electrode layer sheet, and the electrolyte sheet are bent at the bent connection portions and arranged in a substantially zigzag shape.

3. The secondary battery according to claim 1, wherein the electrolyte body is an electrolyte solution; and
the electrolyte layer is composed of the electrolytic solution and a separator.

4. The secondary battery according to claim 1, wherein the bent connection portion is arranged in the negative electrode layer sheet in a manner that one end sides of the adjacent negative electrode current collectors in a depth direction are connected to each other;
the bent connection portion is arranged in the positive electrode layer sheet in a manner that one end sides of the adjacent positive electrode current collectors in the depth direction are connected to each other; and
the battery laminate is configured in a manner that the other end side of the positive electrode layer sheet is disposed on one end side of the negative electrode layer sheet, and one end side of the positive electrode layer sheet is disposed on the other end side of the negative electrode layer sheet, and each of the plurality of positive electrode current collectors and positive electrode active material layers lined up in a width direction is alternately arranged to overlap in order of one surface side, the other surface side, one surface side of each of the plurality of negative electrode current collectors and negative electrode active material layers lined up in the width direction.

5. The secondary battery according to claim 1, wherein the electrolyte layer is disposed on the outermost layer in the lamination direction.

6. The secondary battery according to claim 2, wherein the electrolyte sheet is formed by arranging slits in a portion that is bent together with the negative electrode layer sheet and the positive electrode layer sheet.

7. The secondary battery according to claim 1, wherein an end portion of the bent connection portion of the negative electrode layer sheet, the positive electrode layer sheet, or the electrolyte sheet formed by the slits is formed in a concave arc shape.

8. The secondary battery according to claim 1, wherein the positive electrode active material layer and the negative electrode active material layer adjacent to each other in the lamination direction are formed in a manner that the area of the negative electrode active material layer is equal to or larger than the area of the positive electrode active material layer.

9. The secondary battery according to claim 1, wherein the battery laminate is configured in a manner that the relationship of the dimensions in the depth direction T2 and the width direction T1 in a cross-sectional view is as follows: the dimension of the positive electrode active material layer≤the dimension of the negative electrode active material layer≤the dimension of the electrolyte layer.

10. The secondary battery according to claim 1, wherein the electrolyte body is a solid electrolyte body, and the secondary battery is a solid battery.
